(19) United States
(12) Patent Application Publication
(10) Pub. No.: US 2019/0340766 A1
(43) Pub. Date: Nov. 7, 2019

(54) Apparatus And Method For Filtering With Respect To Analysis Object Image

(71) Applicant: SOMANSA CO., LTD., Seoul (KR)

(72) Inventors: Seung Tae RYU, Seoul (KR); Il Hoon CHOI, Seoul (KR); Tae Wan KIM, Seoul (KR)

(21) Appl. No.: 15/989,413

(22) Filed: May 25, 2018

(30) Foreign Application Priority Data
May 4, 2018 (KR) 10-2018-0051630

(51) Int. Cl. G06T 7/136; G06T 11/00; G06T 7/13; G06T 7/60; G06T 7/50; G06T 7/90; G06K 9/00; G06K 9/32; G06F 21/62

(52) U.S. Cl. CPC G06T 7/136; G06T 11/001; G06T 7/13; G06T 7/60; G06T 2207/20024; G06T 7/90; G06K 9/00449; G06K 9/3258; G06F 21/6245; G06T 7/50

(57) ABSTRACT

Disclosed is a filtering apparatus with respect to an analysis object image. The filtering apparatus includes an image filtering portion configured to determine whether a stored image present in a client is an analysis object image which has a possibility of including a security text, a controlling portion controls transmission of the analysis object image to an analysis server configured to analyze whether the analysis object image includes the security text depending on a result of determination of the image filtering portion, and an interface portion configured to transmit the analysis object image to the analysis server under the control of the controlling portion.

### CROSS-REFERENCE TO RELATED APPLICATION

This application claims priority to and the benefit of Korean Patent Application No. 2018-0051630, filed on May 4, 2018, the disclosure of which is incorporated herein by reference in its entirety.

### FIELD

The present invention relates to an image filtering technology for analyzing image data, and particularly, to an apparatus and a method for filtering with respect to an analysis object image, in which object information of an image (a personal information pattern, an in-house form, and the like) to be analyzed may be previously sorted and transmitted by a client terminal.

### BACKGROUND

Recently, for several years, analog business models have generally been converted into digital business models due to improvement in performance of computers and rapid propagation of Internet. Companies and financial circles collect personal information of customers to provide a variety of services, and the information becomes an object of a security threat. Since collected personal information is stored as an image as well as an electronic document, detection of personal information from an image is a significant area of security.

Although it may be considered to control only electronic documents for protecting personal information, in the case of financial circles or telecommunication companies, identification cards are scanned to carry on business. Here, an image including personal information may be inserted into an electronic document or a screen capture of personal information in an electronic document may be sent or received by an e-mail. As described above, it is not possible to prevent leakage of personal information included in an image by using a general electronic document detection method. Although detection has been performed with several solutions to analyze such images, there are a plurality of obstacle points when a large amount of imagery is processed.

Particularly, network bottlenecks and lack of a server storage are caused by transmission of a large amount of imagery, and resource exhaustion and excessive time consumption are caused by analyzing a large amount of imagery.

### SUMMARY

It is an aspect of the present invention to provide an apparatus and a method for filtering with respect to an analysis object image, in which a large amount of image information to be transmitted for information analysis are previously filtered.

According to one aspect of the present invention, a filtering apparatus with respect to an analysis object image includes an image filtering portion configured to determine whether a stored image present in a client is an analysis object image which has a possibility of including a security text, a controlling portion controls transmission of the analysis object image to an analysis server configured to analyze whether the analysis object image includes the security text depending on a result of determination of the image filtering portion, and an interface portion configured to transmit the analysis object image to the analysis server under the control of the controlling portion.

The image filtering portion may include a color conversion module configured to generate a color-converted image by converting RGB color information of the store image into grayscale information, an edge extraction module configured to extract an edge image with respect to the color-converted image, a frame generation module configured to generate rectangular frames which surround object images included in the edge image, and an analysis object determination module configured to determine whether the stored image is the analysis object image by using at least one of a ratio between a width and a length of each of the object images included in the generated rectangular frames, a distance between the object images, and a slope of height variations.

The frame generation module may generate the rectangular frames on the basis of coordinate values of the object images divided along color boundary lines of the edge image.

The analysis object determination module may determine the stored image as the analysis object image when the ratio between the width and the length of each of the object images is from 0.5 to 2.5.

The analysis object determination module may determine the stored image as the analysis object image when the distance between the object images is at or below two times as long as the width of any one of the object images.

The analysis object determination module may determine the stored image as the analysis object image when the slope of height variations among the object images is 0.25 or less.

The analysis object determination module may determine the stored image as the analysis object image when three or more consecutive object images satisfy all of the ratio between the width and the length of each of the object images included in the rectangular frames, the distance between the object images, and the slope of height variations.

The image filtering portion may further include a form image determination module configured to determine the stored image as a form image included in the analysis object image by comparing a representative color density value which refers to one representative value with respect to the stored image with a reference color density value. Here, the controlling portion may control such that the determined form image is transmitted to the analysis server.

The form image determination module may calculate the representative color density value by using a following equation,

\hat{M}⁽³⁾=σ_{rgyb}+0.3·μ_{rgyb},

σ_{rgyb}:=\sqrt{σ_{rg}²+σ_{yb}²},

μ_{rgyb}:=\sqrt{μ_{rg}²+μ_{yb}²}, [Equation]

in which color information of red (R), green (G), blue (B), and yellow (Y) with respect to the stored image are referred to as RG=|R−G|, BR=|R−B|, GB=|G−B|, and YB=(BR+GB)*0.5, σ_{rg} refers to an average of an overall value of RG, σyb refers to an average of an overall value of YB, μ_{rg} refers to a standard deviation of an overall value of RG, and μ_{yb} refers to a standard deviation of an overall value of YB.

The controlling portion may control the operation of the image filtering portion according to a filtering request signal with respect to the analysis object image or the format image, which is received from the analysis server.

According to another aspect of the present invention, a filtering method with respect to an analysis object image includes determining whether a stored image present in a client is an analysis object image which has a possibility of including a security text and transmitting the analysis object image to an analysis server configured to analyze whether the analysis object image includes the security text depending on a result of determination.

The determining whether the stored image is the analysis object image may include generating a color-converted image by converting RGB color information of the store image into grayscale information, extracting an edge image with respect to the color-converted image, generating rectangular frames which surround object images included in the edge image, and determining whether the stored image is the analysis object image by using at least one of a ratio between a width and a length of each of the object images included in the generated rectangular frames, a distance between the object images, and a slope of height variations.

The generating of the rectangular frames may include generating the rectangular frames on the basis of coordinate values of the object images divided along color boundary lines of the edge image.

The determining of whether the stored image is the analysis object image may include determining the stored image as the analysis object image when the ratio between the width and the length of each of the object images is from 0.5 to 2.5.

The determining of whether the stored image is the analysis object image may include determining the stored image as the analysis object image when the distance between the object images is at or below two times as long as the width of any one of the object images.

The determining of whether the stored image is the analysis object image may include determining the stored image as the analysis object image when the slope of height variations among the object images is 0.25 or less.

The determining of whether the stored image is the analysis object image may include determining the stored image as the analysis object image when three or more consecutive object images satisfy all of the ratio between the width and the length of each of the object images included in the rectangular frames, the distance between the object images, and the slope of height variations.

The filtering method may further include, after the determining whether the stored image is the analysis object image, determining the stored image as a format image included in the analysis object image by comparing a representative color density value which refers to one representative value with respect to color density of the stored image with a reference color density value; and transmitting the determined format image to the analysis server.

The determining of the stored image as the format image may include calculating the representative color density value by using the above-described equation.

The filtering method may further include receiving a filtering request signal with respect to the analysis object image or the format image from the analysis server. Here, in response to the filtering request signal, a filtering operation with respect to the stored image may be performed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration block diagram of an image analysis system including a filtering apparatus with respect to an analysis object image according to one embodiment of the present invention;

FIG. 2 is a configuration block diagram of one embodiment for describing the filtering apparatus with respect to an analysis object image loaded on a client shown in FIG. 1;

FIG. 3 is a configuration block diagram of one embodiment for illustrating an image filtering portion shown in FIG. 2;

FIGS. 4A, 4B, 4C, 4D and 4E are exemplary referential views illustrating operations of the image filtering portion shown in FIG. 3;

FIGS. 5A and 5B are referential views illustrating an object image included in a rectangular frame;

FIG. 6 is an exemplary referential view illustrating three object images included in rectangular frames;

FIG. 7 is another exemplary referential view illustrating three object images included in rectangular frames;

FIG. 8 is a referential view illustrating representative color density values with respect to a plurality of stored images, which are calculated using Equation 1;

FIG. 9 is a flowchart illustrating a filtering method with respect to an analysis object image according to one embodiment of the present invention; and

FIG. 10 is a flowchart illustrating an operation shown in FIG. 9, in which it is determined whether an image is an analysis object image according to one embodiment.

### DETAILED DESCRIPTION

The embodiments of the present invention are provided to more completely explain the present invention to one of ordinary skill in the art. The following embodiments may be modified into a variety of different forms, and the scope of the present invention is not limited thereto. The embodiments are provided to make the disclosure more substantial and complete and to completely convey the concept of the present invention to those skilled in the art.

The terms used herein are to explain particular embodiments and are not intended to limit the present invention. As used herein, singular forms, unless contextually defined otherwise, may include plural forms. Also, as used herein, the term “and/or” includes any and all combinations or one of a plurality of associated listed items.

The present invention is derived to overcome limitations of points of disorder which may occur in an image analysis system. The image analysis system is operated in a 2-tire method. Accordingly, a plurality of clients transmit images to a server through a network, and here, the clients transmit all stored images. The present invention may provide a method of overcoming network bottlenecks and lack of a server storage, which are caused by transmission of a large amount of imagery, and resource exhaustion and excessive time consumption, which are caused by analyzing a large amount of imagery.

Hereinafter, the embodiments of the present invention will be described with reference to the drawings which schematically illustrate the embodiments.

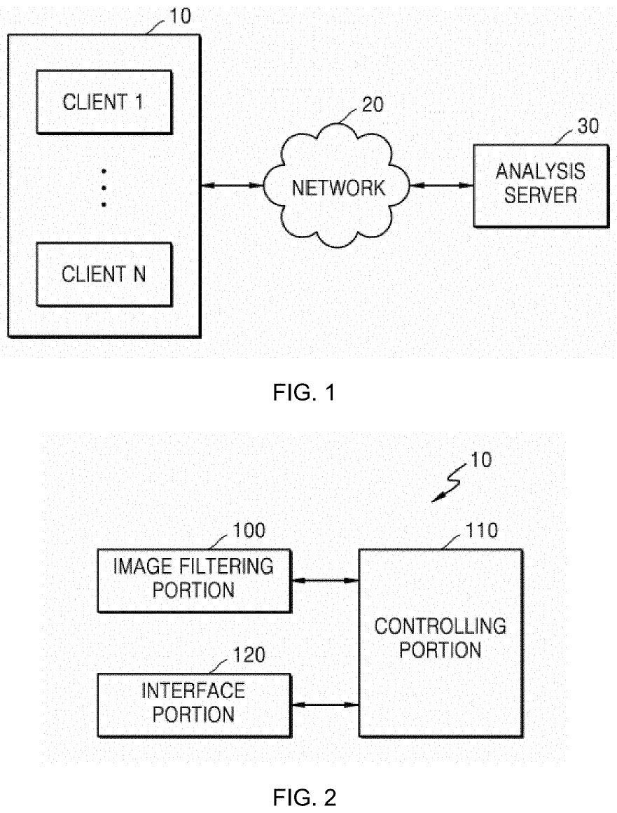

FIG. 1 is a configuration block diagram of an image analysis system including a filtering apparatus with respect to an analysis object image according to one embodiment of the present invention.

Referring to FIG. 1, the image analysis system includes one or more clients 10 (for example, clients 1 to N), a network 20, and an analysis server 30.

The client 10 includes a variety of types of electronic devices which handles personal information in companies, financial circles, or the like. For example, the client 10 may include a desktop personal computer (PC), a laptop PC, a netbook computer, a workstation, an automatic teller's machine (ATM) of a financial institution, a point of sales (PoS) of a store, an Internet of things (IoT) apparatus, or the like.

The client 10 is connected to the analysis server 30 through the network 20. One or a plurality of such clients 10 may be provided. The client 10 includes a filtering apparatus with respect to an analysis object image. The filtering apparatus will be described below in detail.

The network 20 relays data exchange between the client 10 and the analysis server 30. For this, the network 20 includes a wired network and a wireless network. The wired network may include at least one of a universal serial bus (USB), a high definition multimedia interface (HDMI), a recommended standard 232 (RS-232), a plain old telephone service (POTS), and the like. Also, the wired network may include a telecommunications network, for example, a computer network such as a local area network (LAN) and a wide area network (WAN), Internet, a telephone network, and the like. Also, the wireless network may include long term evolution (LTE), LTE advanced (LTE-A), code division multiple access (CDMA), wide CDMA (WCDMA), a universal mobile telecommunication system (UMTS), a wireless broadband (WiBro), a global system for mobile communications (GSM), or the like as a cellular communication protocol and may include wireless fidelity (Wi-Fi), Bluetooth, Zigbee, or the like as short-range wireless communications.

The analysis server 30 performs a function of analyzing whether a stored image present in the client 10 includes a security text. For this, the analysis server 30 is connected to one or a plurality of clients 10 through the network 20. The analysis server 30 transmits a filtering request signal, which requests determination of whether an image stored in the client 10 is an analysis object image, to the corresponding client 10 or transmits a filtering request signal which requests determination of whether an analysis object image is a form image which includes a text form, to the client 10.

When the analysis server 30 transmits the filtering request signal to the client 10, the client 10 may perform a filtering operation with respect to an analysis object image according to the filtering request signal. However, even when the filtering request signal is not transmitted from the analysis server 30, the client 10 may periodically or aperiodically perform the filtering operation with respect to an analysis object image or a form image with respect to stored images according to autonomous scheduling of the client 10. Meanwhile, the analysis server 30 may transmit setting information with respect to filtering, registration information, policy information, and the like, in addition to the filtering request signal, to the client 10.

FIG. 2 is a configuration block diagram of one embodiment for describing the filtering apparatus with respect to an analysis object image loaded on the client 10 shown in FIG. 1.

Referring to FIG. 2, the filtering apparatus includes an image filtering portion 100, a controlling portion 110, and an interface portion 120.

The image filtering portion 100 determines whether a stored image present in the client 10 is an analysis object image and has a possibility of including a security text. The analysis object image is an image to be transmitted to the analysis server 30. The analysis object image has a possibility of including a text which requires security, that is, a security text.

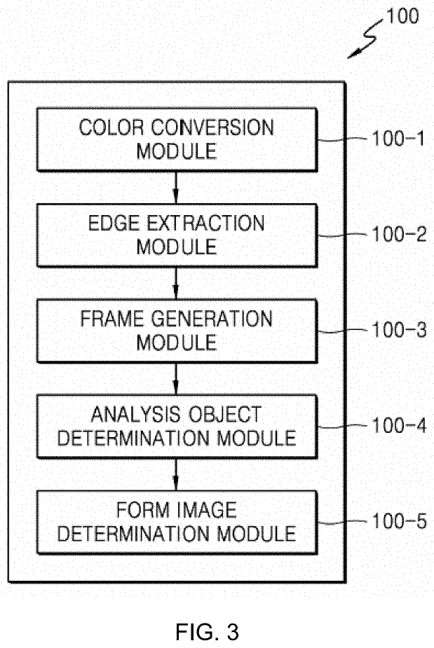

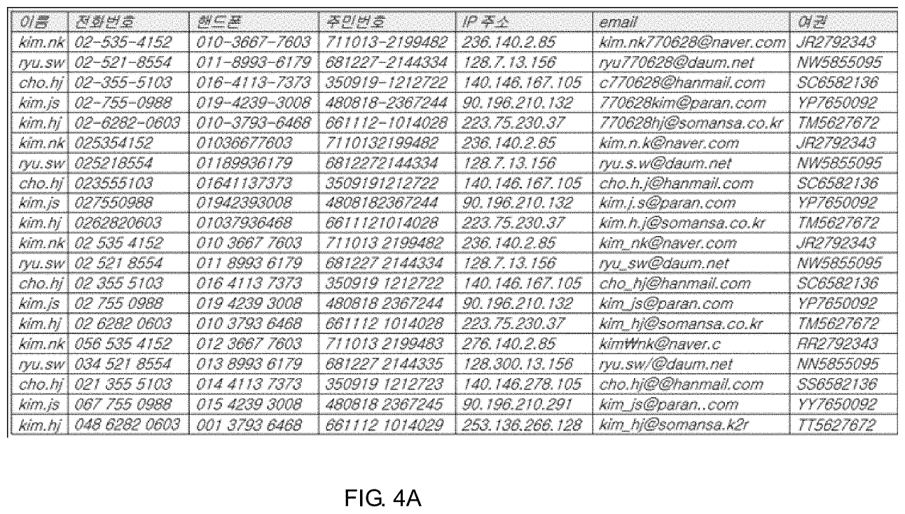

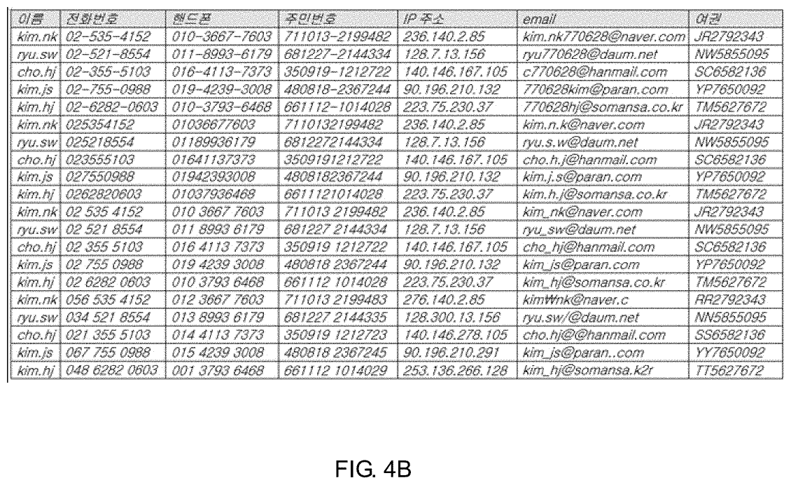

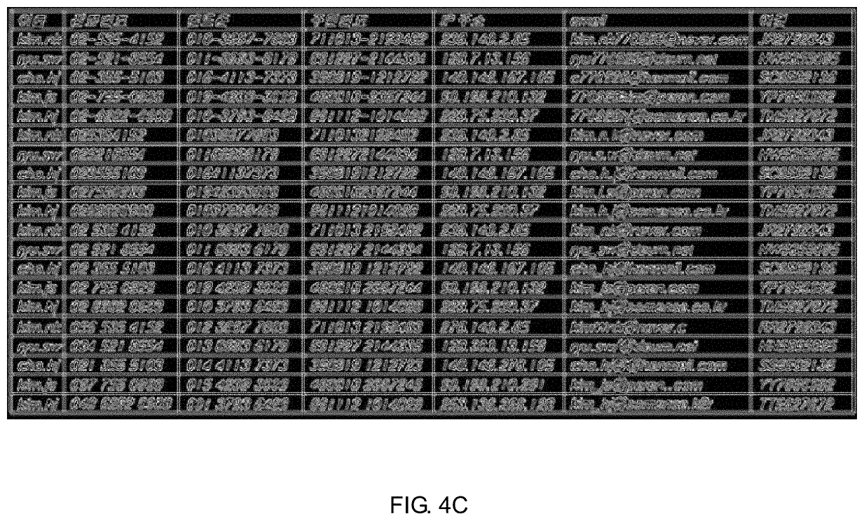

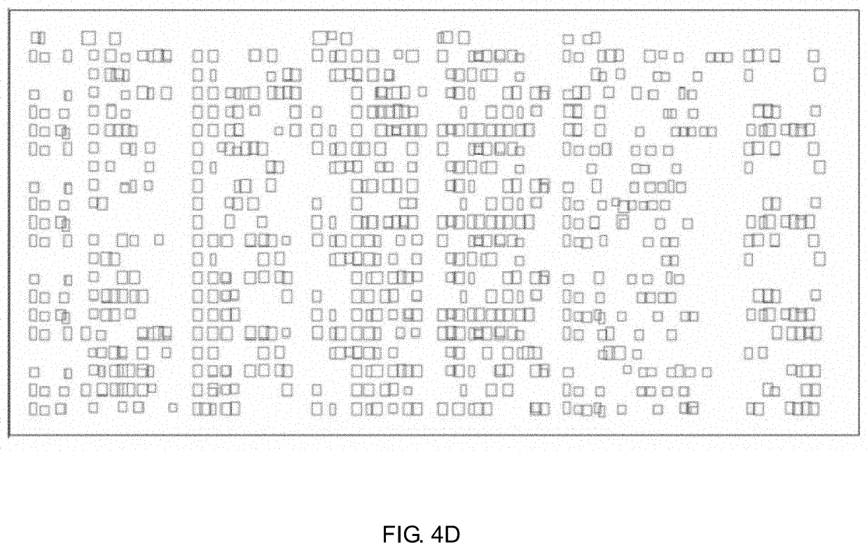

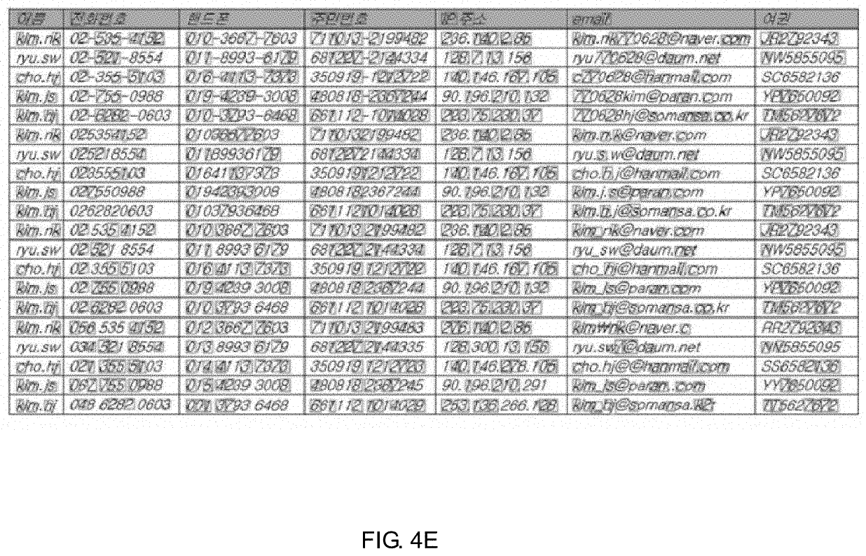

FIG. 3 is a configuration block diagram of one embodiment for illustrating the image filtering portion 100 shown in FIG. 2. Also, FIGS. 4A, 4B, 4C, 4D and 4E are exemplary reference views illustrating operations of the image filtering portion 100 shown in FIG. 3.

Referring to FIG. 3, the image filtering portion 100 may include a color conversion module 100-1, an edge extraction module 100-2, a frame generation module 100-3, an analysis object determination module 100-4, and a form image determination module 100-5.

The color conversion module 100-1 generates a color-converted image by converting RGB color information of a stored image into grayscale information. The color conversion module 100-1 converts RGB color information having colors into grayscale information having black and white and transmits a conversion result to the edge extraction module 100-2.

FIG. 4A is a referential view illustrating a stored image present in the client 10. Also, FIG. 4B is a referential view illustrating a state in which RGB color information with respect to the stored image shown in FIG. 4A has been converted into grayscale information. Referring to FIGS. 4A and 4B, it is possible to see that the stored image having colors has been converted into a color-converted image having black and white colors by the color conversion module 100-1.

The edge extraction module 100-2 extracts an edge image of the color-converted image formed by the color conversion module 100-1. The edge extraction module 100-2 extracts edges, that is, boundary parts of object images in the color-converted images and transmits the extracted edge image to the frame generation module 100-3. The edge extraction module 100-2 extracts suddenly changing color boundary lines from the color-converted image, that is, a grayscale image. Here, the color boundary line refers to a point (edge) at which color changes from black into white or from white into black.

FIG. 4C is a referential view illustrating the edge image extracted from the color-converted image shown in FIG. 4B. Referring to FIG. 4C, it is possible to see that the color image converted into the grayscale image has been converted into an image having color boundary lines by the edge extraction module 100-2.

The frame generation module 100-3 generates rectangular frames for surrounding object images included in the edge image transmitted from the edge extraction module 100-2. Here, the object images have a variety of shapes and sizes and may include figures, things, texts, and the like. The frame generation module 100-3 generates the rectangular frames and then a result of generating the rectangular frames to the analysis object determination module 100-4.

The frame generation module 100-3 generates rectangular frames around the object images to obtain approximate sizes and positions of the object images in the image. For this, the frame generation module 100-3 generates the rectangular frames on the basis of coordinates values of the object images divided according to the color boundary lines of the edge image. That is, the frame generation module 100-3 extracts the color boundary lines connected as the same-colored boundary line to form a closed curve (for example, a contour shape) among the color boundary lines of the edge image as the object images and calculates coordinate information of the above-extracted object images. Here, even when the color boundary lines do not form a completely closed curve such that a part of the closed curve is opened, the frame generation module 100-3 may recognize the incompletely closed curve as a shape of the object and may extract the object image. The frame generation module 100-3 generates the rectangular frames which surround the object images on the basis of the calculated coordinate information.

FIG. 4D is a referential view illustrating the rectangular frames corresponding to the extracted object images the color boundary lines (for example, white boundary lines) from the edge image shown in FIG. 4C. That is, FIG. 4D illustrates the coordinate information of the rectangular frame according to extracting the object image from the edge image shown in FIG. 4C. Also, FIG. 4E is a referential view illustrating a state in which the rectangular frames shown in FIG. 4D and the object images are shown together.

Referring to FIGS. 4D and 4E, it is possible to see that the rectangular frames generated by extracting the edges and the object images form the color-converted image surround the object images.

The analysis object determination module 100-4 determines whether the stored image is the analysis object image by using at least one of a ratio between a width and a length of each of the object images included in the rectangular frames, a distance between the object images, and a slope of height variations. Then, the analysis object determination module 100-4 may transmit a result of determining the stored image as the analysis object image to the form image determination module 100-5.

The analysis object determination module 100-4 determines the stored image in the client 10 as the analysis object image when the ratio between the width and the length of each of the object images are 0.5 to 2.5.

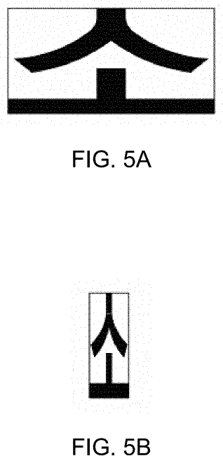

FIGS. 5A and 5B are referential views illustrating the object image included in the rectangular frame. FIG. 5A illustrates a case when a ratio between a width and a length of the object image is 1:0.5, and FIG. 5B illustrates a case when a ratio between the width and the length is 1:2.5. Referring to FIGS. 5A and 5B, when the ratio between the width and the length of the object image is less than 0.5 or more than 2.5, the object image may not be a text. Accordingly, the analysis object determination module 100-4 may calculate a width and a length of an object image by using pixel values and may determine a stored image including the corresponding object image as the analysis object image when a ratio between the calculated width and length is from 0.5 to 2.5.

Also, when the slope of height variations between the object images are 0.25 or less, the analysis object determination module 100-4 may determine the corresponding stored image as the analysis object image.

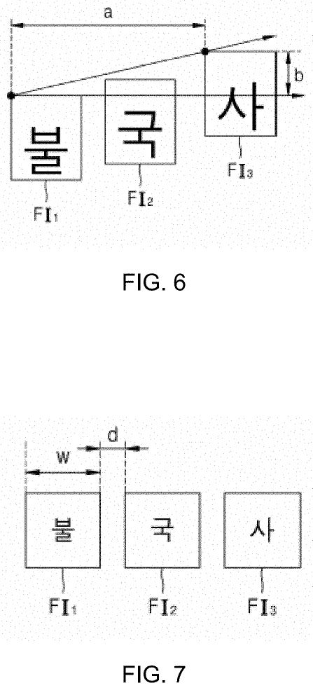

FIG. 6 is an exemplary referential view illustrating three object images included in quadrangular frames. Referring to FIG. 6, an object image 1 FI₁, an object image 2 FI₂, and an object image 3 FI₃ are included in the stored image. A slope of height variations of the object image 1 FI₁, the object image 2 FI₂, and the object image 3 FI₃ may be calculated using an equation in which a slope of height variations=b/a. Here, a refers to a horizontal distance between certain points (for example, coordinates of top ends of left sides of frames) of the two object images FI₁ and FI₃, and b refers to a vertical distance between the certain points of the two object images FI₁ and FI₃. However, here, the certain point is merely an example and may be a randomly determined point in the rectangular frame which forms the object image.

A slope of height variations among object images may be calculated by comparing variations of certain points of other object images on the basis of a certain point of an object image located on the leftmost part (for example, coordinates of a top end of a left side of a frame). Here, when the slope of height variations exceeds 0.25, it is quite possible that the object image is not text. Accordingly, the analysis object determination module 100-4 may calculate coordinate information with respect to the certain points of the object images and may determine the corresponding stored image as the analysis object image when the slope of height variations according to the horizontal distance and the vertical distance between the object images (that is, the ratio of the vertical distance to the horizontal distance) is 0.25 or less.

Also, when the distance between the object images is at or below two times as long as the width of any one of the object images, the analysis object determination module 100-4 may determine the stored image as the analysis object image.

FIG. 7 is another exemplary referential view illustrating three object images included in rectangular frames. Referring to FIG. 7, an object image 1 FI₁, an object image 2 FI₂, and an object image 3 FI₃ are included in the stored image.

A width of the object image 1 FI₁ is referred to as w, and a distance between the object image 1 FI₁ and the object image 2 FI₂ is referred to as d.

Here, the distance d between the object image 1 FI₁ and the object image 2 FI₂ exceeds two times as long as the width w of the object image 1 FI₁, it is quite possible that the corresponding object image FI₁ or the object image 2 FI₂ is not a text. Accordingly, the analysis object determination module 100-4 may calculate the distance between the object images, may determine whether the calculated distance is at or below two times as long as the width of any one of the object images through comparison therebetween, and may determine the corresponding stored image as the analysis object image when the distance is at or below two times as long as the width of any one of the object images.

Meanwhile, although the analysis object determination module 100-4 may determine a stored image which satisfies any one of the ratio between the width and the length of each of the object images included in the rectangular frames, the distance between the object images, and the slope of height variations as the analysis object image as described above, the analysis object determination module 100-4 may determine only a stored image which satisfies all of the ratio between the width and the length of each of the object images included in the rectangular frames, the distance between the object images, and the slope of height variations as the analysis object image. Also, only when three or more consecutive object images satisfy all the above three conditions, the analysis object determination module 100-4 may determine the stored image including the corresponding object images as the analysis object image.

The form image determination module 100-5 compares a representative color density value which refers to one representative value of color density of the stored image with a reference color density value and determines the stored image as a form image included in the analysis object image. That is, the form image determination module 100-5 determines whether the stored image determined as the analysis object image is an image including a text prepared according to a document form template, that is, corresponds to a form image.

The form image determination module 100-5 may calculate a representative color density value \hat{M}⁽³⁾ by using following Equation 1,

\hat{M}⁽³⁾=σ_{rgyb}+0.3·μ_{rgyb},

σ_{rgyb}:=\sqrt{σ_{rg}²+σ_{yb}²},

μ_{rgyb}:=\sqrt{μ_{rg}²+μ_{yb}²}, [Equation 1]

in which color information of red (R), green (G), blue (B), and yellow (Y) with respect to the stored image are referred to as RG=|R−G|, BR=|R−B|, GB=|G−B|, and YB=(BR+GB)*0.5, σ_{rg} refers to an average of an overall value of RG, σyb refers to an average of an overall value of YB, μ_{rg} refers to a standard deviation of an overall value of RG, and μ_{yb} refers to a standard deviation of an overall value of YB.

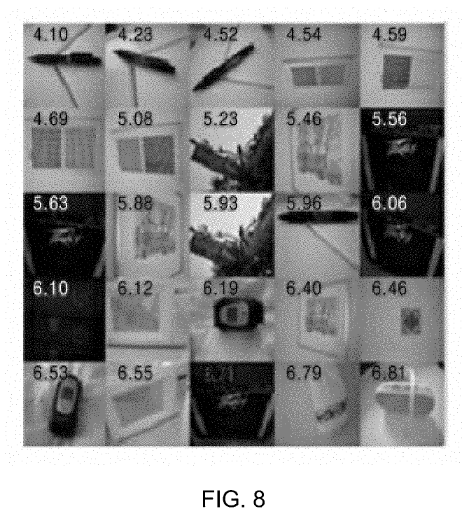

The form image determination module 100-5 calculates a representative color density value of the stored image by using Equation 1. FIG. 8 is a referential view illustrating representative color density values with respect to a plurality of stored images, which are calculated by using Equation 1. Referring to FIG. 8, values shown in the stored images indicate representative color density values of the stored images.

The form image determination module 100-5 may configure separate matrixes corresponding to R, G, and B with respect to the stored image, may obtain an absolute value with respect to a difference between pixels of the separate matrixes, and may obtain an average or a standard deviation of an overall value of YB and RB to calculate a representative color density value with respect to the stored image. Table 1 exemplifies representative color density values calculated by using Equation 1.

TABLE 1

| Attribute | M⁽¹⁾ | M⁽²⁾ | M⁽³⁾ |
|---|---|---|---|
| not colourful | 0 | 0 | 0 |
| slightly colourful | 6 | 8 | 15 |
| moderately colourful | 13 | 18 | 33 |
| averagely colourful | 19 | 25 | 45 |
| quite colourful | 24 | 32 | 59 |
| highly colourful | 32 | 43 | 82 |
| extremely colourful | 42 | 54 | 109 |

The form image determination module 100-5 compares the calculated representative color density value with the reference color density value and determines the stored image having the corresponding representative color density value to be the form image when the calculated representative color density value is at or below the reference color density value. Here, the reference color density value is a color density value for determining whether the stored image is the form image. When the representative color density value exceeds the reference color density value, the stored image corresponds to an image having a variety of colors such that it is quite possible that the stored is not the form image. On the other hand, when the representative color density value is at or below the reference color density value, the stored image corresponds to an image having simple colors such that it is quite possible that the stored image is the form image.

The controlling portion 110 controls an operation of the image filtering portion 100 according to the filtering request signal with respect to the analysis object image or the form image received from the analysis server 30. The filtering request signal transmitted from the analysis server 30 may be an analysis object filtering request signal for filtering analysis object images from a plurality of images stored in the client 10 or may be a form image filtering request signal for filtering the form image from the analysis object images. Also, even when a filtering request signal is not received from the analysis server 30, the controlling portion 110 may control periodic or aperiodic performance of the filtering operation with respect to analysis object images from stored images or form images according to autonomous scheduling information.

When the analysis object filtering request signal is received from the analysis server 30, the controlling portion 110 transmits a control signal for filtering out an analysis object image to the image filtering portion 100. Accordingly, the image filtering portion 100 determines the analysis object image from the stored images as described above. When the form image filtering request signal is received from the analysis server 30, the controlling portion 110 transmits a control signal for filtering out a form image to the image filtering portion 100. Accordingly, the image filtering portion 100 determines the form image from the images stored in the client 10 as described above.

Then, the controlling portion 110 controls the interface portion 120 to transmit the stored image determined as the analysis object image to the analysis server 30 depending on a result of determination of the image filtering portion 100. Also, the controlling portion 110 controls the interface portion 120 to transmit the stored image determined as the form image to the analysis server 30 depending on the result of determination of the image filtering portion 100.

When a filtering request signal with respect to an analysis object image or a form image is transmitted from the analysis server 30, the interface portion 120 receives the filtering request signal (for example, an analysis object filtering request signal or a form image filtering request signal) and transmits the received filtering request signal to the controlling portion 110. Then, the interface portion 120 transmits an analysis object image or a form image to the analysis server 30 under the control of the controlling portion 110.

The interface portion 120 is connected to the network 20 to perform wired or wireless communications to receive a filtering request signal or to transmit an analysis object image and a form image. For this, the interface portion 120 may include a wired communication module and a wireless communication module to perform wired communications or wireless communications.

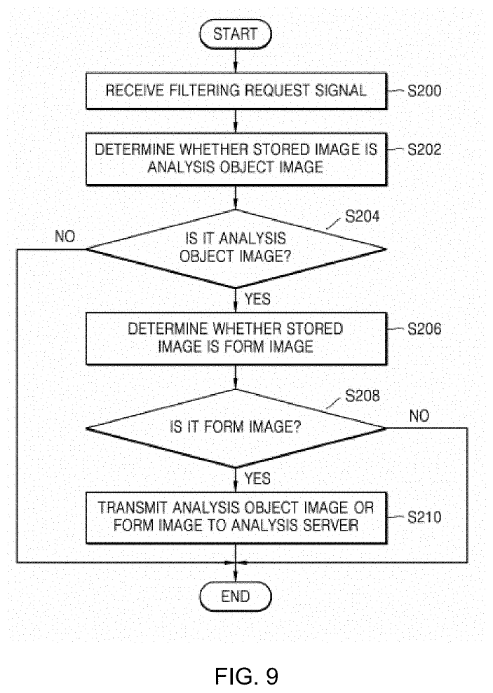

FIG. 9 is a flowchart illustrating a filtering method with respect to an analysis object image according to one embodiment of the present invention.

The filtering apparatus receives a filtering request signal with respect to an analysis object image or a form image, which is transmitted from the analysis server (S200). The filtering request signal transmitted from the analysis server may be an analysis object filtering request signal for filtering out analysis object images from a plurality of images stored in the client or may be a form image filtering request signal for filtering out the form image from the analysis object images. However, since the filtering apparatus may perform according to autonomous scheduling information in the client, the filtering apparatus may operate according to the scheduling information even when the filtering request signal is not received from the analysis server.

After operation S200, in response to the filtering request signal, the filtering apparatus determines whether a stored image present in the client is an analysis object image (S202). The analysis object image is an image which has a possibility of including a text which requires security, that is, a security text.

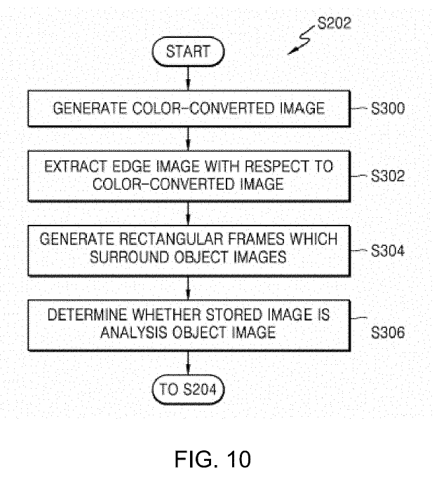

FIG. 10 is a flowchart illustrating operation S202 shown in FIG. 9, in which it is determined whether an image is an analysis object image according to one embodiment.

The filtering apparatus converts RGB color information of the stored image present in the client into grayscale information to generate a color-converted image (S300). The filtering apparatus converts the RGB color information having colors into the grayscale information having black and white colors to generate the color-converted image.

After operation S300, the filtering apparatus extracts an edge image with respect to the generated color-converted image (S302). The filtering apparatus extracts suddenly changing color boundary lines from the color-converted image, that is, a grayscale image.

After operation S302, the filtering apparatus generates rectangular frames which surround object images included in the edge image (S304). The filtering apparatus generates the rectangular frames on the basis of coordinate values of the object images divided along the color boundary lines of the edge image. That is, the filtering apparatus extracts color boundary lines, which are connected as boundary lines having the same color to form a closed curve, as the object images among the color boundary lines of the edge image. Here, even when the color boundary lines do not form a completely closed curve such that a part of the closed curve is opened, the filtering apparatus may recognize the incompletely closed curve as a shape of the object and may extract the object image. The filtering apparatus calculates coordinate information of each of the extracted object images. Then, the filtering apparatus generates rectangular frames which surround the object images on the basis of the calculated coordinate information.

After operation S304, the filtering apparatus determines whether the stored image is the analysis object image by using at least one of a ratio between a with and a length of each of the object images included in the rectangular frames, a distance between the object images, and a slope of height variations (S306).

The filtering apparatus may determine the stored image in the client to be the analysis object image when the ratio between the width and the length of each of the object images is from 0.5 to 2.5. The filtering apparatus may calculate a width and a length of an object image by using pixel values and may determine a stored image including the corresponding object image as the analysis object image when a ratio between the calculated width and length is from 0.5 to 2.5.

Also, when a slope of height variations between the object images are 0.25 or less, the filtering apparatus may determine the corresponding stored image as an analysis object image. On the basis of a certain point of an object image located on the leftmost part (for example, coordinates of a top end of a left side of a frame), the filtering apparatus may calculate the slope of height variations by comparing variations in certain points of other object images. That is, the filtering apparatus may calculate coordinate information with respect to the certain points within the object images and may determine the corresponding stored image as the analysis object image when a slope of height variations according to widths and lengths among object images is 0.25 or less according to the calculated coordinate information.

Also, when a distance between the object images is at or below two times as long as a width of any one of the object images, the filtering apparatus may determine the stored image as the analysis object image. The filtering apparatus may calculate the distance between the object images, may determine whether the calculated distance is at or below two times as long as the width of any one of the object images through comparison therebetween, and may determine the corresponding stored image as the analysis object image when the distance is at or below two times as long as the width of any one of the object images.

Meanwhile, although the filtering apparatus may determine a store image which satisfies any one of a ratio between a width and a length of each of object images included in rectangular frames, a distance between the object images, and a slope of height variations as the analysis object image, the filtering apparatus may determine only a store image which satisfies all of the ratio between the width and the length of each of the object images included in the rectangular frames, the distance between the object images, and the slope of height variations as the analysis object image. Here, only when three or more consecutive object images satisfy all the above three conditions, the filtering apparatus may determine the store image including the corresponding object images as the analysis object image.

After operation S202, depending on a result of determination on whether the stored image present in the client is the analysis object image (S204), when the stored image is determined as the analysis object image, the filtering apparatus compares a representative color density value which refers to a representative value of color density of the stored image with a reference color density value and determines the stored image as a form image included in the analysis object image (S206).

The filtering apparatus calculates the representative color density value by using Equation 1. The filtering apparatus may configure separate matrixes corresponding to R, G, B and Y with respect to the stored image, may obtain an absolute value with respect to a difference between pixels of the separate matrixes, and may obtain an average or a standard deviation of an overall value of YB and RB to calculate the representative color density value with respect to the stored image. The filtering apparatus compares the calculated representative color density value with the reference color density value and determines the stored image having the corresponding representative color density value to be the form image when the calculated representative color density value is at or below the reference color density value.

However, since it is unnecessary to essentially perform operation S206, operation S206 is omissible. Accordingly, after operation S204, operation S210 may be performed to transmit the analysis object image as follows.

After operation S204, when the stored image corresponds to the analysis object image, the filtering apparatus transmits the analysis object image to the analysis server (S210). Meanwhile, after S206, depending on a result of determination on whether the analysis object image is a form image (S208), when the analysis object image corresponds to the form image, the filtering apparatus transmits the form image to the analysis server (S210). The filtering apparatus may transmit the analysis object image or the form image to the analysis server through wired communications or wireless communications.

The analysis server may receive the analysis object image or the form image from the client. Then, the analysis server may compare the received form image with a prestored original form image and highlights a part of a text area in the received form image.

According to the embodiments of the present invention, images including texts and in-house form images among images generated at a plurality of client terminals are analyzed and determined by the plurality of client terminals to minimize the number of images transmitted to an analysis server such that network bottlenecks and lack of a server storage, which are caused by transmission of a large amount of imagery, and resource exhaustion and excessive time consumption, which are caused by analyzing a large amount of imagery, may be prevented.

The exemplary embodiments of the present invention have been described above. One of ordinary skill in the art may understand that modifications may be made without departing from the scope of the present invention. Therefore, the disclosed embodiments should be considered in a descriptive aspect not a limitative aspect. The scope of the present invention is defined by the claims not the above description, and it should be understood that all differences within the equivalents thereof are included in the present invention.

What is claimed is:

1. A filtering apparatus with respect to an analysis object image, comprising:
an image filtering portion configured to determine whether a stored image present in a client is an analysis object image which has a possibility of including a security text;
a controlling portion controls transmission of the analysis object image to an analysis server configured to analyze whether the analysis object image includes the security text depending on a result of determination of the image filtering portion; and
an interface portion configured to transmit the analysis object image to the analysis server under the control of the controlling portion.

2. The filtering apparatus of claim 1, wherein the image filtering portion comprises:
a color conversion module configured to generate a color-converted image by converting RGB color information of the store image into grayscale information;
an edge extraction module configured to extract an edge image with respect to the color-converted image;
a frame generation module configured to generate rectangular frames which surround object images included in the edge image; and
an analysis object determination module configured to determine whether the stored image is the analysis object image by using at least one of a ratio between a width and a length of each of the object images included in the generated rectangular frames, a distance between the object images, and a slope of height variations.

3. The filtering apparatus of claim 2, wherein the frame generation module generates the rectangular frames on the basis of coordinate values of the object images divided along color boundary lines of the edge image.

4. The filtering apparatus of claim 2, wherein the analysis object determination module determines the stored image as the analysis object image when the ratio between the width and the length of each of the object images is from 0.5 to 2.5.

5. The filtering apparatus of claim 2, wherein the analysis object determination module determines the stored image as the analysis object image when the distance between the object images is at or below two times as long as the width of any one of the object images.

6. The filtering apparatus of claim 2, wherein the analysis object determination module determines the stored image as the analysis object image when the slope of height variations among the object images is 0.25 or less.

7. The filtering apparatus of claim 2, wherein the analysis object determination module determines the stored image as the analysis object image when three or more consecutive object images satisfy all of the ratio between the width and the length of each of the object images included in the rectangular frames, the distance between the object images, and the slope of height variations.

8. The filtering apparatus of claim 1, wherein the image filtering portion further comprises a form image determination module configured to determine the stored image as a form image included in the analysis object image by comparing a representative color density value which refers to one representative value with respect to the stored image with a reference color density value, and
wherein the controlling portion controls such that the determined form image is transmitted to the analysis server.

9. The filtering apparatus of claim 8, wherein the form image determination module calculates the representative color density value by using a following equation,
\hat{M}⁽³⁾=σ_{rgyb}+0.3·μ_{rgyb},
σ_{rgyb}:=\sqrt{σ_{rg}²+σ_{yb}²},
μ_{rgyb}:=\sqrt{μ_{rg}²+μ_{yb}²}, [Equation]
wherein color information of red (R), green (G), blue (B), and yellow (Y) with respect to the stored image are referred to as RG=|R−G|, BR=|−B|, GB=|G−B|, and YB=(BR+GB)*0.5, σ_{rg} refers to an average of an overall value of RG, σyb refers to an average of an overall value of YB, μ_{rg} refers to a standard deviation of an overall value of RG, and μ_{yb} refers to a standard deviation of an overall value of YB.

10. The filtering apparatus of claim 8, wherein the controlling portion controls the operation of the image filtering portion according to a filtering request signal with respect to the analysis object image or the form image, which is received from the analysis server.

11. A filtering method with respect to an analysis object image, the method comprising:
determining whether a stored image present in a client is an analysis object image which has a possibility of including a security text; and
transmitting the analysis object image to an analysis server configured to analyze whether the analysis object image includes the security text depending on a result of determination.

12. The filtering method of claim 11, wherein the determining whether the stored image is the analysis object image comprises:
generating a color-converted image by converting RGB color information of the store image into grayscale information;
extracting an edge image with respect to the color-converted image;
generating rectangular frames which surround object images included in the edge image; and
determining whether the stored image is the analysis object image by using at least one of a ratio between a width and a length of each of the object images included in the generated rectangular frames, a distance between the object images, and a slope of height variations.

13. The filtering method of claim 12, wherein the generating of the rectangular frames comprises generating the rectangular frames on the basis of coordinate values of the object images divided along color boundary lines of the edge image.

14. The filtering method of claim 12, wherein the determining of whether the stored image is the analysis object image comprises determining the stored image as the analysis object image when the ratio between the width and the length of each of the object images is from 0.5 to 2.5.

15. The filtering method of claim 12, wherein the determining of whether the stored image is the analysis object image comprises determining the stored image as the analysis object image when the distance between the object images is at or below two times as long as the width of any one of the object images.

16. The filtering method of claim 12, wherein the determining of whether the stored image is the analysis object image comprises determining the stored image as the analysis object image when the slope of height variations among the object images is 0.25 or less.

17. The filtering method of claim 12, wherein the determining of whether the stored image is the analysis object image comprises determining the stored image as the analysis object image when three or more consecutive object images satisfy all of the ratio between the width and the length of each of the object images included in the rectangular frames, the distance between the object images, and the slope of height variations.

18. The filtering method of claim 11, further comprises:
after the determining whether the stored image is the analysis object image, determining the stored image as a form image included in the analysis object image by comparing a representative color density value which refers to one representative value with respect to color density of the stored image with a reference color density value; and
transmitting the determined form image to the analysis server.

19. The filtering method of claim 18, wherein the determining of the stored image as the form image comprises calculating the representative color density value by using a following equation,
\hat{M}⁽³⁾=σ_{rgyb}+0.3·μ_{rgyb},
σ_{rgyb}:=\sqrt{σ_{rg}²+σ_{yb}²},
μ_{rgyb}:=\sqrt{μ_{rg}²+μ_{yb}²}, [Equation]
wherein color information of red (R), green (G), blue (B), and yellow (Y) with respect to the stored image are referred to as RG=|R−G|, BR=|R−B|, GB=|G−B|, and YB=(BR+GB)*0.5, σ_{rg} refers to an average of an overall value of RG, σyb refers to an average of an overall value of YB, μ_{rg} refers to a standard deviation of an overall value of RG, and μ_{yb} refers to a standard deviation of an overall value of YB.

20. The filtering method of claim 18, further comprising receiving a filtering request signal with respect to the analysis object image or the form image from the analysis server,
wherein in response to the filtering request signal, a filtering operation with respect to the stored image is performed.
